(19) United States
(12) Patent Application Publication
(10) Pub. No.: US 2013/0220837 A1
(43) Pub. Date: Aug. 29, 2013

(54) SYSTEMS AND METHODS FOR CARBOHYDRATE DETECTION

(71) Applicant: University of Hawaii, (US)

(72) Inventors: Bor Yann Liaw, Honolulu, HI (US); Daniel Marin Scott, Kaneohe, HI (US)

(73) Assignee: University of Hawaii, Honolulu, HI (US)

(21) Appl. No.: 13/856,315

(22) Filed: Apr. 3, 2013

Related U.S. Application Data
(63) Continuation of application No. 12/912,700, filed on Oct. 26, 2010, now abandoned.
(60) Provisional application No. 61/279,896, filed on Oct. 26, 2009.

(51) Int. Cl. G01N 27/26

(52) U.S. Cl. CPC G01N 27/26
USPC 205/782

(57) ABSTRACT

Carbohydrate detectors employing abiotic fuel cell designs are disclosed. The detectors produce current output using reactions between chemical dyes in alkaline solutions and carbohydrates, such as glucose. A linear relationship between current output of the detector and glucose concentration has been observed. This relationship may be used with measurements of current output when the glucose concentration is unknown to determine the unknown glucose concentration. In certain embodiments, the abiotic detectors may further employ electrodes, such as high surface area carbon materials and commercial air breathing electrodes, without the use of catalysts (i.e., precious metals or biocatalytic species) for glucose detection Organic dyes, such as methyl viologen (MV), methylene blue, methylene green, Meldola's blue, indigo carmine, safranin O, and the like, may serve as the electron mediators.

### CROSS-REFERENCE TO RELATED APPLICATIONS

This Continuation application claims the benefit of priority under 35 U.S.C. §119(e) of U.S. Non-Provisional application Ser. No. 12/912,700 filed on Oct. 26, 2010, entitled, “SYSTEMS AND METHODS FOR CARBOHYDRATE DETECTION.”, which claims the benefit of priority under 35 U.S.C. §119(e) of Provisional Application No. 61/279,896 filed on Oct. 26, 2009, entitled, “AMPEROMETRIC GLUCOSE SENSORS USING ORGANIC MEDIATOR DYES.” The entirety of this application is hereby incorporated by reference.

### STATEMENT REGARDING FEDERALLY SPONSORED R&D

This invention was made with Government support under The Intelligence Community Postdoctoral Fellow Research Program, Contract Number HM1582-04-1-2013, awarded by the National Geospatial Intelligence Agency. The Government has certain rights in this invention.

### BACKGROUND OF THE INVENTION

1. Field

Embodiments of the present disclosure are generally directed to sensing carbohydrates and, in particular, to systems and methods for detection of carbohydrates such as glucose.

2. Description of the Related Art

Glucose sensors have been desired for biomedical and industrial applications from clinical diagnosis to environmental monitoring and food processing. For example, glucose detection in blood and urine can be used for diabetes diagnosis. Monitoring glucose content in fermentation is critical for food processing control.

Glucose sensors have been under development for several decades. One approach has employed glucose oxidase (GOx) as a glucose detection agent. However, detectors based upon GOx often suffer from low stability due to the nature of the enzymes. Furthermore, interference from chlorides is often observed in GOx-based detectors. Another approach has employed non-enzymatic detection agents. However, previous non-enzymatic approaches suffer from short lifetimes as catalytic surfaces quickly expire due to poisoning from alternative reactions. Such catalysts are also generally precious metals and are cost prohibitive in nature.

### SUMMARY OF THE INVENTION

In an embodiment, a method of measuring the concentration of a carbohydrate in a sample. The method comprises contacting an anode and a cathode with two or more first alkaline solutions, the alkaline solutions each comprising a known concentration of the carbohydrate and a mediator dye selected from the group consisting of azides and carmines. The method further comprises identifying a correlation between the current output resulting from contacting the anode and the cathode with each of the two or more first alkaline solutions and the concentration of carbohydrate in the first alkaline solutions. The method additionally comprises contacting the anode and the cathode with a second alkaline solution comprising the sample, wherein the sample comprises an unknown concentration of the carbohydrate. The method also comprises measuring a current output resulting from contact of the anode and the cathode with the second alkaline solution. The method additionally comprises determining the concentration of the selected carbohydrate within the second alkaline solution using the identified correlation.

In another embodiment, a method of correlating a current output to a carbohydrate concentration is provided. The method comprises performing a first reaction process comprising: reacting a known concentration of a selected carbohydrate with an oxidized form of a dye and hydroxide ions in an alkaline solution to yield at least a reduced from of the dye and an oxidized form of the carbohydrate; oxidizing the dye at the anode to recover the oxidized form of the dye and one or more electrons; and reacting oxygen with water and the one or more produced electrons at a cathode to form hydroxide ions. The method further comprises measuring a correlation between the current resulting from the first reaction process and the concentration of the selected carbohydrate.

In a further embodiment, a method of determining a concentration of a carbohydrate within a sample is provided. The method comprises contacting an anode and a cathode with a solution comprising a dye selected from the group consisting of azides and carmines and a carbohydrate. The method further comprises measuring the current output resulting from contact of the anode and cathode with the solution. The method additionally comprises determining the concentration of the carbohydrate based upon a relationship between the current output and the concentration of the carbohydrate under approximately identical conditions.

### BRIEF DESCRIPTION OF THE DRAWINGS

FIG. 1 presents a schematic illustration of an embodiment of a carbohydrate-oxygen alkaline detector for measuring the concentration of carbohydrates (e.g., glucose) within the detector;

FIG. 2 presents chemical structures of embodiments of electron mediators for use in embodiments of the detectors of FIG. 1;

FIG. 3 is an exemplary flow chart illustrating a method for employing the detector of FIG. 1;

FIG. 4 illustrates an embodiment of a fabricated detector;

FIGS. 5A-5C are polarization and power curves and illustrate the dependence of the detector performance upon the concentration of glucose, organic dye, and base illustrating the ability to detect glucose concentrations under current limiting conditions; (A) glucose (with about 10 mM methyl viologen and about 3 M KOH), (B) methyl viologen (with about 1 M glucose and about 3 M KOH), and (C) KOH (with about 1 M glucose and about 10 mM methyl viologen);

FIGS. 6A-6C illustrate the dependence of current generation on the concentration of components in embodiments of the detectors; (A) glucose (with about 10 mM methyl viologen and about 3 M KOH), (B) methyl viologen (with about 1 M glucose and about 3 M KOH), and (C) KOH (with about 1 M glucose and about 10 mM methyl viologen);

FIG. 7 illustrates the dependence of limiting current on glucose concentration in an embodiment of a glucose detector employing indigo carmine as the dye mediator;

FIG. 8 illustrates the current output of a detector comprising arabinose with about 10 mM methyl viologen and about 2 M KOH;

FIG. 9 illustrates a durability test of an embodiment of a detector comprising about 1.6 mL of about 400 mM glucose in about 6 mM methyl viologen and about 1 M KOH under a galvanostatic polarization of about 0.7 mA; and

FIG. 10 illustrates the current output of the detector of FIG. 1 as aliquots of glucose were added to a solution containing only about 1 M KOH and about 4 mM methyl viologen initially to increase the glucose concentration by about 10 mM each time.

### DETAILED DESCRIPTION OF THE PREFERRED EMBODIMENT

Embodiments of the present disclosure are directed to systems and methods for the detection of carbohydrates such as glucose. Glucose or other carbohydrates to be detected may be employed as a fuel within a detector that operates based upon a fuel cell design. Organic dyes are employed as electron mediators in a redox reaction with the carbohydrate to be detected that generates current output. The current output of the detector exhibits a defined relationship with carbohydrate concentration. In certain embodiments, the current output of the detector is approximately linear with carbohydrate concentration. As a result, the output (e.g., current output) of the carbohydrate detector may be calibrated using a known concentration of a known carbohydrate to determine the relationship between carbohydrate concentration and detector output. Once calibrated, current output of the detector when an unknown concentration of the selected carbohydrate is present may be employed to determine the concentration of the carbohydrate. It may be understood that, while embodiments of the disclosure may discuss sensing with respect to glucose, the concentration of other carbohydrates may be sensed without limit.

In an embodiment, detectors of the present disclosure may employ organic dyes in alkaline solutions to generate electrical power using glucose as a fuel. In certain embodiments, the detector designs may further employ electrodes, such as high surface area carbon materials and air breathing electrodes, without the use of catalysts (e.g., precious metals or biocatalysts) for glucose oxidation. Organic dyes, including but not limited to, methyl viologen (MV), methylene blue, methylene green, Meldola's blue, indigo carmine, safranin O, and the like, may be included within the detector. As discussed in greater detail below, these organic dyes may function as electron mediators in redox reactions taking place within the detector that result in the current output of the detector.

As discussed in greater detail below, current output of the disclosed detectors may vary approximately in a predictable manner (e.g., linearly) with the concentration of glucose or other carbohydrates over a wide range of concentrations. For example, the current output of the detector may remain approximately linear with glucose concentrations from about 10 mM to at least about 500 mM. Therefore, glucose concentrations may be accurately measured over this range. In further embodiments, the range over which carbohydrates, such as glucose, may be sensed can extend up to about the saturation point of the carbohydrate in the solution placed within the detector.

Thus, known concentrations of a selected carbohydrate may be used to calibrate the detector. For example, the current output of the detector may be measured with a range of known concentrations of the selected carbohydrate to determine the relationship between current output and carbohydrate concentration and thus establish a calibration for the detector with the selected carbohydrate. The detector can then be employed under similar conditions (e.g., dye, base, dye concentration, base concentration, temperature, pressure, etc.) with an unknown concentration of the selected carbohydrate and the calibration can be used to determine the unknown carbohydrate concentration. In this fashion, carbohydrate concentration may be easily measured over a substantially wider range than has been previously achievable.

The current output of the detectors may also vary with the organic dye employed and the pH of the solution within the device. As a result, detection limits and sensitivity may be tuned to a desired level of interest by using different organic dyes and different pH.

In a further aspect, embodiments of the disclosed detectors may operate under short circuit conditions that require no external power to operate (e.g., the detectors are self-powered).

In some embodiments of the detectors and detection methods discussed herein, the reaction of the carbohydrate with a hydroxide-containing base can provide a source of electrons that can be transferred to the organic mediator dye. This process may occur without the assistance of a catalyst at the anode of the detector. The absence of catalysts at the detector anode may allow embodiments of the disclosed detectors to operate across a wide temperature range. Furthermore, the reaction is specific, and electron transfer is facile, such that a separator between the positive electrode and negative electrode to separate the two half-cell reactions (e.g., fuel and oxygen) may be omitted in some embodiments. In addition, in some embodiments the detectors may operate aerobically and in other embodiments they may operate anaerobically.

The cost of producing detectors disclosed in some embodiments is also relatively low. For example, the cost of materials such as the dyes and electrodes may be relatively low. These costs may be further reduced, in some embodiments, by the absence of precious metal catalysts. The detector costs may also be further reduced in some embodiments by substantially avoiding complicated engineering. For example, as discussed below, some embodiments of the disclosed detectors do not utilize a membrane to separate the carbohydrate (e.g., glucose) and air compartments. Additionally, in some embodiments, the electrodes do not require design elements such as nano-size catalysts or multi-layer architectures, which may increase both the cost and complexity of the detectors.

Thus, the detectors of the present disclosure can be simple, inexpensive, and efficient. In some embodiments, the detectors are free of precious metals at the anode (negative electrode), open to air, and do not contain a membrane. Furthermore, the detector operation may be generally within the temperature and pressure range that the alkaline solution remains stable in fluid, for example, about room temperature. Additionally, the power output of the detectors may be relatively stable over long hours before the glucose within a sample to be measured for glucose concentration is exhausted. The response time of the detectors is also relatively rapid. In certain embodiments, carbohydrate concentrations may be measured within approximately 7 to 15 minutes from addition of the carbohydrate to the detector. These and other advantages of embodiments of the disclosed detectors are discussed in detail below.

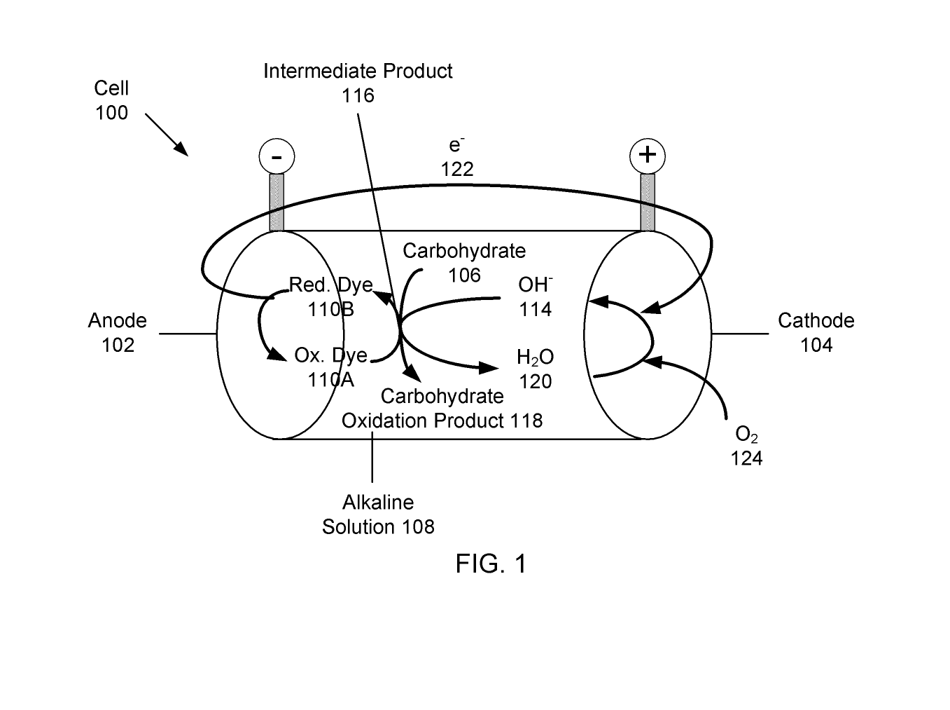

FIG. 1 illustrates a detector 100 for glucose detection. The detector may comprise an anode (negative electrode) 102 and a cathode (positive electrode) 104 which are positioned between an alkaline solution 108 comprising a carbohydrate 106 and a dye 110. The dye 110 may adopt an oxidized form 110A and a reduced form 110B, as discussed below.

In some embodiments, the anode 102 may comprise one or more materials having a high surface area that are electrochemically and chemically stable in the alkaline solution 108. In certain embodiments, the surface area of the anode 102 may vary within the range from about 0.01 m²/g to about 1,000 m²/g. In other embodiments, the surface area of the anode may be greater than about 1 m²/g. In some embodiment, the anode 102 may comprise a carbon felt.

In other embodiments, the anode 102 may comprise a glassy carbon material. Glassy carbon materials may present a more well-defined accessible surface area, which is about the same as the geometric area, enabling a more accurate measure of accessible surface area. This in turn may provide a more accurate measurement of power and current density output of the detector.

In some embodiments, the cathode 104 may comprise an air breathing cathode. The air breathing cathode materials may be obtained from commercial sources, which use materials such as platinum (Pt) and other transition metals and their oxides-based catalysts on electrode supports. In other embodiments, the cathode 104 may comprise other redox couples that are capable of providing electrochemical pathways to complete the reactions taking place within the detector 100 and provide sufficient potential differences for power generation.

A carbohydrate 106 that is to be detected operates as the fuel source for the detector 100. When operating as a glucose sensor, glucose 106 may function as the fuel source for the detector 100. In certain embodiments, the detector may be configured to detect other carbohydrates by employing such carbohydrates in lieu of glucose. The carbohydrate 106 may include one of monosaccharides, disaccharides, oligosaccharides, and/or polysaccharides. Monosaccharides may include, but are not limited to, one or more of arabinose, sorbose, and fructose in addition to glucose. In further embodiments, the carbohydrate may comprise a carbohydrate that exhibits a concentration-current output relationship similar to the monosaccharides discussed above.

As discussed in greater detail below, the range over which the concentration of carbohydrate 106 within the alkaline solution 108 may be detected may be from less than about 0.01 mM to about supersaturation of the carbohydrate within different alkaline conditions 108. In other embodiments, the range over which the concentration of the carbohydrate 106 within the alkaline solution 108 may range between about 0.01 mM to about 0.1 mM, from about 0.1 mM to about 1 mM, from about 1 mM to about 10 mM, from about 10 mM to about 100 mM, from about 100 mM to about 500 mM, from about 500 mM to about 1000 mM, from about 1M to about 2M, which approaches saturation.

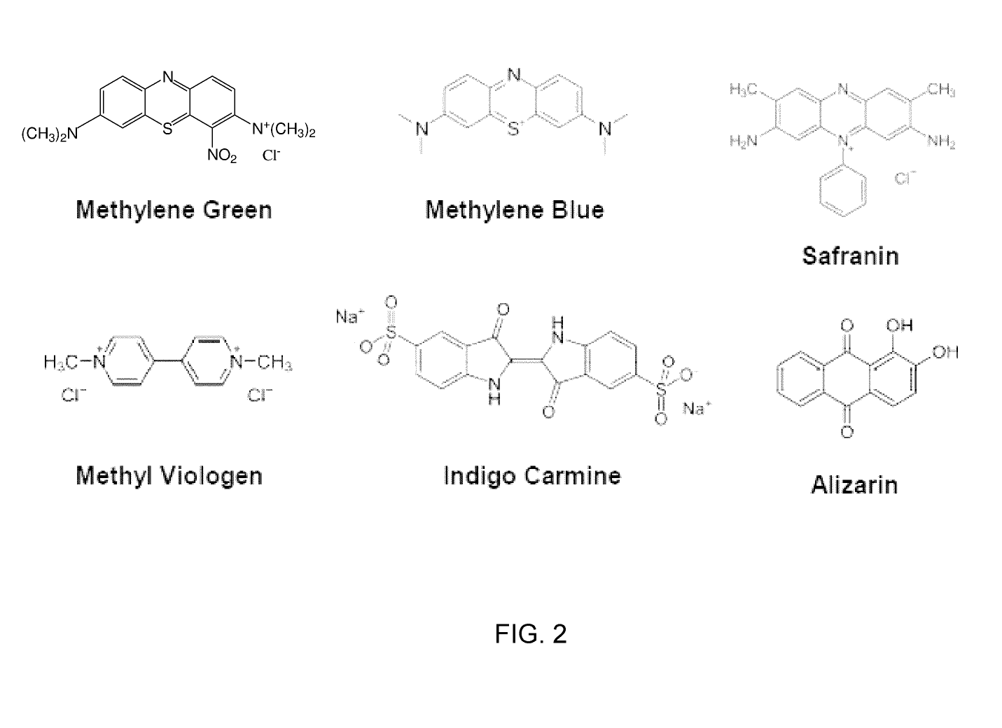

In some embodiments, the dye 110 serves as an electron mediator. Embodiments of suitable dye mediators may include azines and carmines. Specific examples of dye mediators may include, but are not limited to, Meldola's blue (MB), methyl viologen (MV), methylene blue, methylene green, indigo carmine, safranin O, and other similar dyes that can shuttle the electrons. Examples of the structures of these compounds are illustrated in FIG. 2. The concentration of the dye within the alkaline solution 108 may range between less than about 1 mM to about the solubility limit at the specific temperature of operation. In other embodiments, the concentration of the dye 110 within the alkaline solution 108 may vary within the range of about 0.1 mM to about 1 mM, from about 1 mM to about 5 mM, from about 5 mM to about 10 mM, from about 10 mM to about 20 mM, about 20 mM to about 30 mM, about 30 mM to about 40 mM, about 40 mM to about 50 mM and greater than about 50 mM.

In some embodiments, the alkaline solution 108 may comprise a base. Bases suitable for the detector 100 may include, but are not limited to, hydroxides. Examples of hydroxides may include, but are not limited to, potassium hydroxide (KOH), sodium hydroxide (NaOH), lithium hydroxide (LiOH), and other basic materials that can provide hydroxide ions in the solution. The concentration of the base within the alkaline solution 108 is sufficient to obtain the desired pH and may range, for example, between less than about 1 mM to concentrated solutions (e.g., 2M OH⁻ and greater). Examples of concentrations may vary within the range of about 0.1 mM to about 1 mM, from about 1 mM to about 100 mM, from about 10 mM to about 100 mM, from about 100 mM to about 1000 mM, from about 1 M to about 2 M, from about 2 M to about 3 M, and greater than about 3M. The base may be further provided in a concentration sufficient to yield an alkaline solution 108 with a pH greater than about 7. For example, in certain embodiments, the pH may range between 7-8, 8-9, 9-10, 10-11, 11-12, 12-13, 13-14, and greater than 14. Notably, substantially no degradation of the dye mediators is observed when operating under high pH conditions, for example, at pH greater than 12 or pH greater than 14.

The detector 100 may operate under a wide range of pressures. For example, embodiments of the detectors disclosed herein may operate to generate power for carbohydrate detection at pressures at about atmospheric pressure, above atmospheric pressure, and below atmospheric pressure. Embodiments of pressure ranges may include, but are not limited to, about 100 torr to 300 torr, about 300 torr to 500 torr, about 500 torr to about atmospheric pressure (e.g., about 750 torr), about atmospheric pressure (e.g., 1 atmosphere) to 3 atmospheres, about 3 atmospheres to 5 atmospheres, and greater than about 5 atmospheres.

Without being bound by theory, in some embodiments, the detector 100 may operate as follows. The alkaline solution 108 may be provided with a known carbohydrate 106, such as glucose, and an oxidized form of the dye 110. The carbohydrate may react in the presence of the oxidized dye 110A with the hydroxide 114 to yield an intermediate product 116. This intermediate product 116, in the presence of the oxidized dye 110A, may further react to form a carbohydrate oxidation product 118 (e.g., a glucose reaction product), water (H₂O) 120, and reduced dye 110B. In some embodiments the alkaline solution 108 does not comprise a catalyst. An example of such a reaction for glucose is illustrated below. As discussed above, when detection of carbohydrates other than glucose is desired, such carbohydrates may be substituted for glucose and a carbohydrate oxidation product results

Carbohydrate(106)+Oxidized Dye(110A)+OH⁻(114)→Carbohydrate Oxidation Product 118+H₂O(120)+Reduced Dye(110B)

The reduced dye 110B may shuttle the electron 122 and reoxidize on the anode surface.

Reduced Dye(110B) [symbol] Oxidized Dye(110A)+e⁻(122)

On the cathode, oxygen (O₂) 124 may react with water 120 and the electrons 122 to form hydroxide ions 114.

O₂(124)+2H₂O(120)+4e⁻(122)→4OH⁻(114)

Thus, on net, the inputs of carbohydrate 106 and oxygen 124 yield a carbohydrate oxidation product 118 and water (H₂O), without substantially producing carbon dioxide (CO₂) while producing electrical power.

2 Carbohydrate(106)+O₂(124)→2 Carbohydrate Oxidation Product(118)+2H₂O(120)

Without being bound by theory, is believed that the dye 110 functions in the detector 100 as a mediator, rather than as a catalyst. A catalyst does not serve in a reaction as a reactant or product but serves as an agent which promotes the kinetics of a reaction. For example, a catalyst may lower the activation energy barrier of the reaction and enhance the reaction rate constant in the rate equation. In contrast, mediators are electrochemical species that facilitate charge transfer through their ability to transfer electrons between active reaction sites and current collector surface via fast transport in the solution to enable a shuttle mechanism to complete a redox reaction. So, the mediators alter the equilibrium in the concentrations of the reactants and products under the Le Chatelier's principle. The continuous removal of the electrons may shift the equilibrium and propel the reaction to continue until the reaction cannot be sustained. Thus, embodiments of the detectors disclosed herein employ dyes 110 as mediators, rather than catalysts, for power generation. In some embodiments, no catalysts are used in the system.

Beneficially, embodiments of the disclosed detectors and related methods may operate to stably generate power at a broad range of temperatures, as the reactions occurring within the detectors are not strongly dependent upon the temperature of operation. For example, in certain embodiments, the operating temperatures may fall within the range from about the freezing temperature of the reactants detectors to the decomposition temperature of the reactants. In other embodiments, the operating temperatures may fall within the range of about −40° C. to about 300° C., from about −40° C. to about room temperature (e.g., about 20-25° C.), from about room temperature to about 150° C., and from about room temperature to about 40° C. In additional embodiments, the operating temperature of the detectors may be maintained at approximately normal human temperature, approximately 37° C. In other embodiments, the operating temperature of the detectors may be maintained at temperatures ranging between about 20° C. to 25° C., 25° C. to about 30° C., and 30° C. to about 35° C.

It may be further noted that embodiments of the disclosed detectors may be substantially ecologically friendly. As discussed in greater detail below, dye mediators 110 such as food dyes (e.g., indigo carmine) may be employed. These non-toxic dyes are less harmful to the environment than dyes such as viologens and, under certain circumstances, may be preferred for use. Furthermore, the reaction products resulting from use of the detector are a carbohydrate oxidation product (e.g., a glucose oxidation product 118) and water.

Additionally, as discussed in greater detail below, the operating time of the detectors of the present disclosure, without altering the alkaline solution, through stirring or adjustment of the pH or the use of buffers, is significant. For example, the detector may provide power output without substantial adjustment for hours or even days. In contrast, alternative technologies may require continued adjustment of the solution pH to maintain reaction conditions.

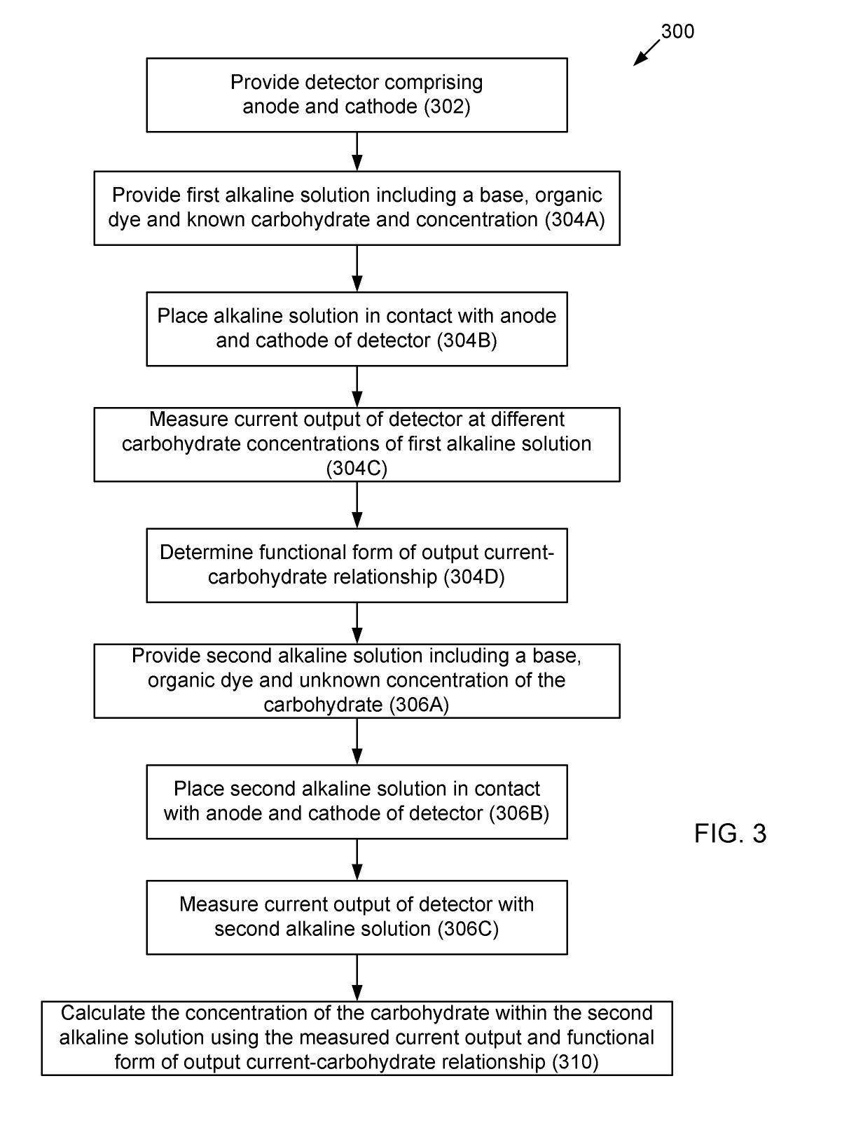

An embodiment of a method 300 for employing the detector to measure glucose concentration is illustrated in FIG. 3. In operation 302, a detector 100 comprising the anode and cathode is provided, as discussed above.

In operations 304A-304D, a current-concentration relationship may be determined for a known carbohydrate. In operation 304A, an alkaline solution including a known concentration of a known carbohydrate is provided. The alkaline solution may comprise the known carbohydrate (in a known concentration), a selected base, and a selected organic dye, as further discussed above. In operation 304B, the alkaline solution may be placed in contact with the anode and cathode of the detector 100 at a selected temperature and pressure. In certain embodiments, the selected temperature and pressure may depend upon one or more of the organic dye, the known carbohydrate, and the base. In operation 304C, the current output of the detector 100 may be measured when the alkaline solution is placed into contact with the anode and cathode of the detector 100.

The operations 304A-304C may be repeated, at least twice and up to as many times as desired, each time using the known carbohydrate in a different but known concentration in order to measure the current-concentration relationship for the known carbohydrate. In certain embodiments, the output current of the detector 100 may be measured in each instance after a selected time period (e.g., a response time of the detector). In certain embodiments, the response time may be selected to be a time after which the current output of the detector 100 remains approximately constant. In one embodiment, the response time may be greater than about 7 minutes.

In operation 304D, the measured current-concentration relationship may be fit to a mathematical equation for modeling. In one embodiment, should the current-concentration relationship be described by a linear functional form, the current-concentration relationship may be described by y=m*x+b, where y is the current output of the detector 100 for known carbohydrate concentration x. and b is the y-intercept of the linear functional form.

In operation 306, the current output of an unknown concentration of a known carbohydrate may be determined using the detector 100. In operation 306A, an alkaline solution is prepared using the same base and organic dye as employed during the calibration measurements. In operation 306B, a sample including an unknown concentration of the carbohydrate is added to the alkaline solution. In operation 306C, the temperature and pressure of the alkaline solution and detector are provided to be approximately equal to those employed when determining the current-concentration relationship of the known carbohydrate. In operation 306D, the alkaline solution including the unknown concentration of the known carbohydrate is added to the detector 100. In operation 306D, the current output of the detector may be measured after the response time of the detector 100.

In operation 310, the current output of the unknown concentration of the known carbohydrate may be employed with the current-concentration relationship determined in operation 304 to determine the concentration of the carbohydrate within the sample added to the alkaline solution in operation 306B. The functional form of the current-concentration relationship may be rewritten to solve for the concentration of the carbohydrate. For example, assuming that the current-concentration relationship is linear, the current-concentration relationship may be rewritten as follows:

y=m*x+b

x=(y−b)/m

As y is known from the current output measurement and m and b are known from the current-concentration relationship, x may be readily determined. Although the method 200 is discussed in the context of a linear current-concentration relationship, it may be understood that, provided a current concentration measurement determined as discussed above, one of skill in the art may rewrite this relationship to solve for carbohydrate concentration without limit.

### EXAMPLES

In the examples below, the manufacture and performance of embodiments of detectors for carbohydrate detection are illustrated. It may be understood that these examples are presented for illustrative purposes and should not be construed to limit the scope of the disclosed embodiments.

The cathode material for the experiments discussed below was an air-breathing oxygen-reduction cathode comprising a silver-plated nickel screen electrode with approximately 0.6 mg/cm² loading using approximately 10% Pt on Vulcan XC-72 (Cabot Corp, Billerica, Mass.) with a micro-porous, fluorocarbon backing (BASF) used in the as-received condition without treatment. The anode material, unless otherwise noted, was a carbon felt with a thickness of about 3.18 mm (Product No. 43199, Alfa Aesar). Methyl viologen (MV), methylene green, and all other dyes, potassium hydroxide (KOH), glucose and other carbohydrates were purchased from Sigma-Aldrich and were used without further purification.

A BioLogic 16-channel VMP3 potentiostat/galvanostat was used to conduct all electrochemical measurements. In the detector, the air-breathing cathode was exposed to the open air without any substantial additional air flow or air enrichment. The concentrations of each of the dyes, KOH, and glucose (or other carbohydrate) were employed as given below. All experiments were conducted at approximately room temperature and about ambient pressure. Platinum wire was used for the electrode contact to inhibit corrosion interference.

An embodiment of an actual detector is illustrated in FIG. 3. As illustrated in FIG. 3, the detector does not employ a separator interposed between the cathode and anode to separate the two half-cell reactions taking place in the detector.

### Example 1

### Carbohydrate Detector Having Varied Glucose, Methyl Viologen, and KOH Concentrations

Three experiments were conducted in Example 1 to examine the effects of varying glucose concentration, methyl viologen concentration, and KOH concentration on the performance of the detector. The triangles represent the detector voltage and the circles represent power density. In each case, the baseline concentration for the three constituent reagents maintained the ratio of glucose:methyl viologen:KOH at about 2 M: about 28 mM: about 3 M, respectively. The concentration of glucose was varied within the range of about 60 mM to about 500 mM, the concentration of methyl viologen was varied within the range of about 1 mM to about 4 mM, and the concentration of KOH was varied within the range of about 0.25 M to about 1 M. Substantially no stirring or agitation of the solution was applied to the detector during power production.

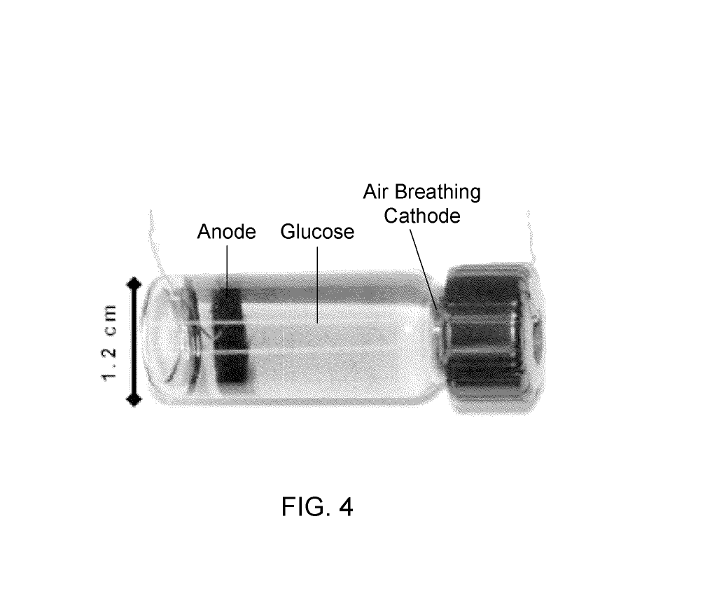

FIGS. 4A-4C illustrate polarization curves (steady state detector voltage versus polarization current density profiles) showing the dependence of detector performance on the concentration of glucose (4A), methyl viologen (4B), and KOH (4C). A steady state voltage after each current step can be reached in about 20-30 minutes, if not shorter.

In this detector, an open circuit voltage of about 0.675 V (500 mM glucose in about 4 mM MV and about 1 M KOH solution) was achievable with little dependence on the glucose concentration. In this case, the anode was at about −0.655 V versus Ag/AgCl, which is approximately to what is expected for the formal redox potential of methyl viologen. The air-breathing cathode was at about 0.02 against Ag/AgCl. The ability to achieve the expected potential at the anode indicates the facile kinetics exerted by the electrode to reach equilibrium on the electrode surface, with respect to the methyl viologen redox reaction.

Upon galvanostatic polarization under different operating conditions, the detector voltage follows a common descending trend line, where the shape of the trend line shows little dependence upon the reagents' concentration. This common profile exhibits a rather low activation polarization loss, indicating that the polarization is likely dominated by the electrolyte conductivity, as shown by the dependence on the KOH concentration (in FIG. 4C), until the reaction reaches a purported mass transport limitation. The power profiles reflect the same behavior, as shown by the common power generation curve that spans over a wide range of reagents' concentration. For example, while the glucose concentration varies over about 8-fold, the corresponding power profiles are generally overlapping.

Notably, though, the reagents concentration does affect the maximum power and limiting current. This unique behavior, as illustrated by the concentration dependence in the power generation, highlights the merits of this chemistry, which takes advantage of the facile kinetics exhibited by the organic dye redox (in this case, MV) for current generation. As illustrated in FIGS. 4A-4C, the detector may generate more than about 45 μA/cm² at about 0.43 V, or about 20 μW/cm² with a solution comprising about 500 mM glucose, 4 mM MV, and about 1 M KOH.

The surface area used in the derivation is the actual surface area specified by the vendor for the carbon felt (a disk about 2.2 cm² by 3.18 mm thick and 38 mg). This is equivalent to approximately 0.53 mW/g or about 2.1 mW/cm³ of anode based on the weight or density of the carbon felt. A short-circuit current of about 52 μA/cm² was measured under the same condition.

The limiting current depicted by a precipitous drop off from the maximum power generation to the short circuit condition is illustrated in FIGS. 4A-4C. This behavior is different from the more gradual tail off commonly observed in the mass-transport regime. This drop off behavior, in conjunction with the common trend line that is substantially independent of reagent concentration, is evidence for a reaction kinetic limitation regime, as opposed to the more traditional mass-transport limitation.

### Example 2

### Dependence of Current Generation on Glucose, MV, and KOH Concentrations

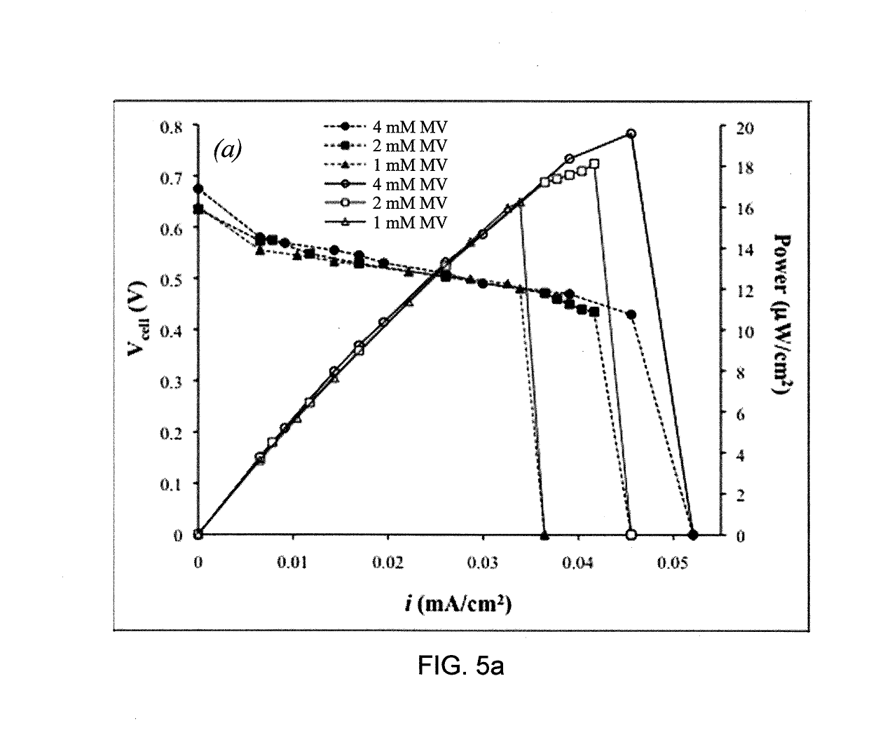

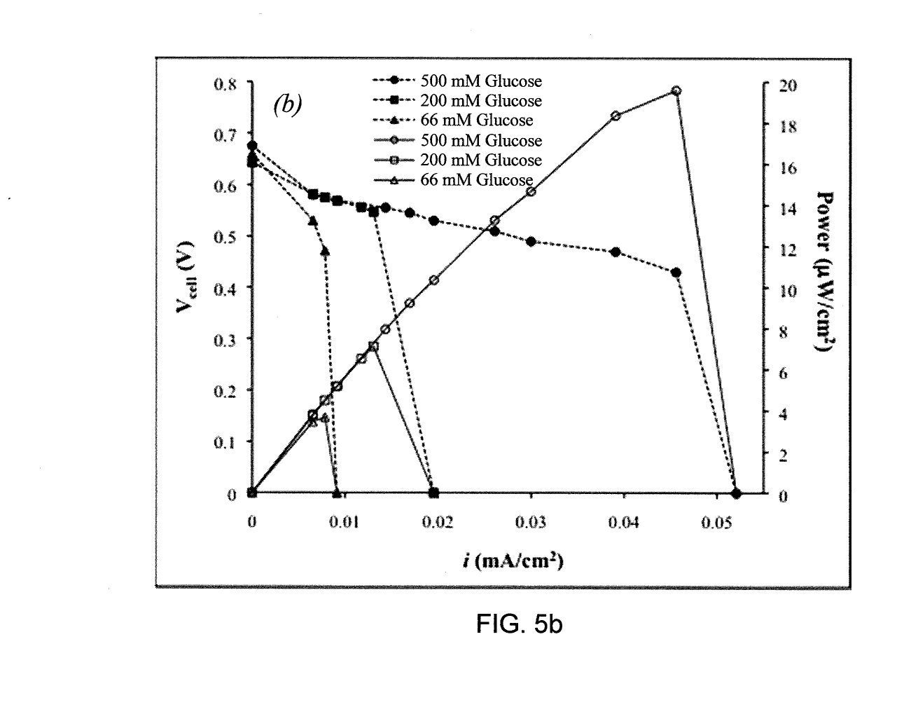

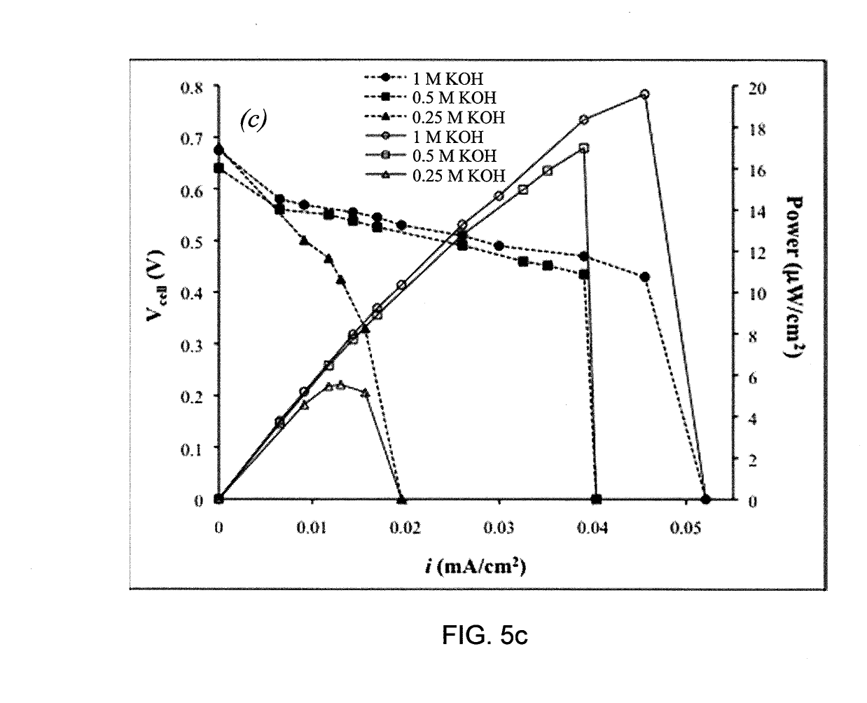

Experiment 2 explored the influence of reagent concentration on the limiting current of the detector. FIGS. 5A-5C illustrate experimental results for limiting current as a function of glucose concentration (FIG. 5A), MV concentration (FIG. 5B), and KOH concentration (FIG. 5C). In each case, the concentration for the non-varying constituent reagents was: glucose about 1 M, methyl viologen about 10 mM, and KOH about 3M. Glucose concentration is observed to vary linearly with the glucose concentration, as shown in FIG. 5A. In contrast, MV and KOH concentrations follow a second order dependence with MV.

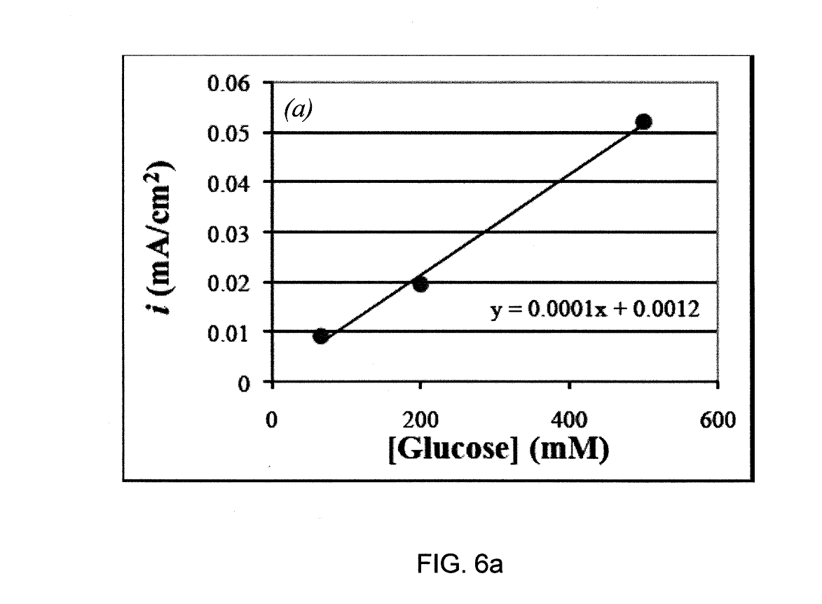

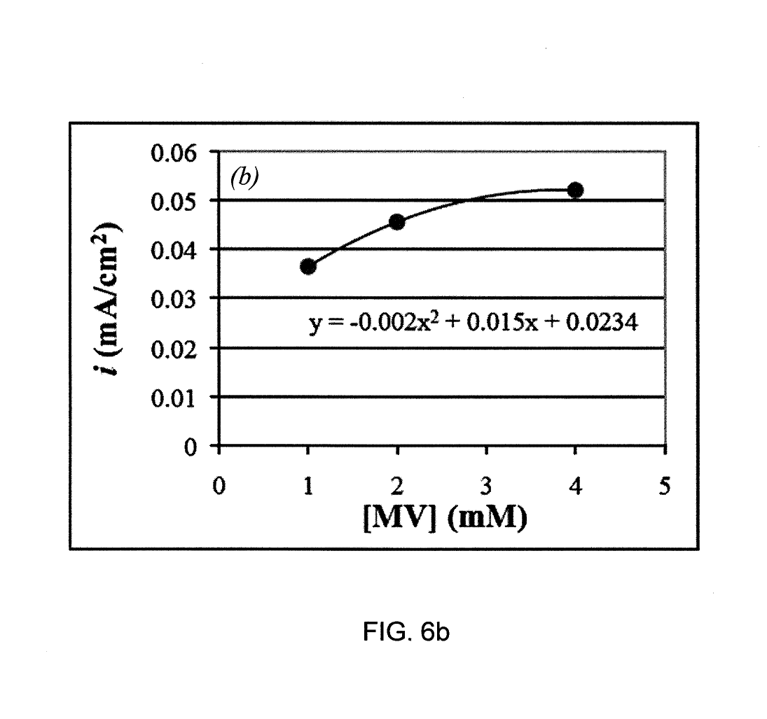

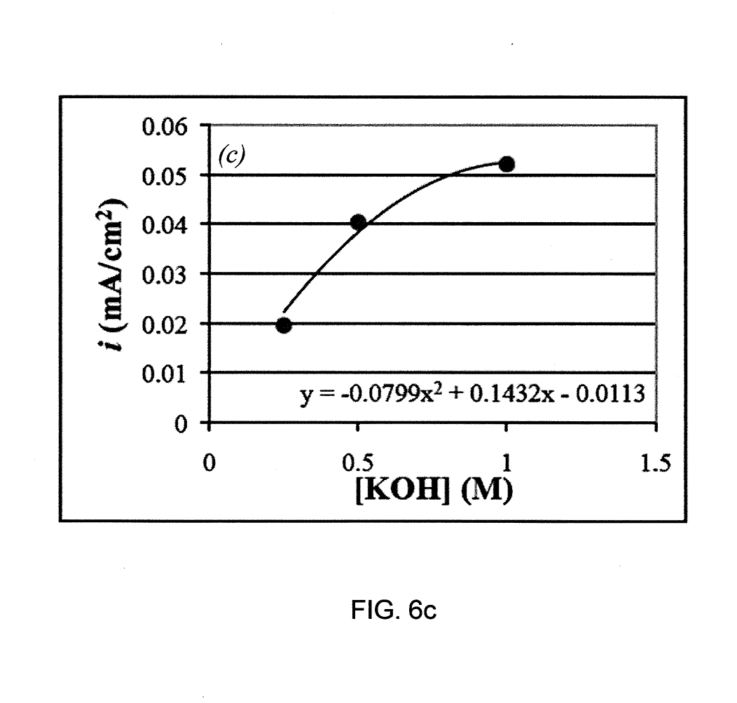

Other dye mediators may also be employed in the detector. Embodiments of such dyes may include, but are not limited to, Meldola's blue (MB), methylene blue, methylene green, indigo carmine, and safranin O. FIG. 6 illustrates the relationship between glucose concentration and current density using indigo carmine as the organic mediator dye. This experiment further included a base different from that of the test of FIG. 5, NaOH.

In the experiment of FIG. 6, the detector comprised a MnO₂ cathode embedded on carbon paper. The anode comprised carbon felt. The detector was operated at about room temperature under a constant voltage of about 0.1 V to measure the limiting current as a function of glucose concentration. The assay solution comprised about 10 mM indigo carmine and about 6M NaOH. Glucose concentration was varied within the range between about 0 M to about 0.4 M.

As illustrated in FIGS. 5 and 6, the output current density varies approximately linearly with glucose concentration over the entire range of glucose concentrations examined, about 10 mM to about 500 mM glucose in MV and about 0 mM to about 400 mM in indigo carmine. As a result, linear correlations may be determined by measuring current output of the detector for known concentrations of a selected carbohydrate. Current output of the detector for unknown concentrations of the selected carbohydrate may also be measured. Using the linear correlation and the current output measured for the selected carbohydrate to the concentration of the carbohydrate may be determined.

Furthermore, the trend line remains approximately linear to about 0 mM glucose concentration. Therefore, embodiments of the detector may be employed to measure relatively small glucose concentrations (e.g., approaching 0 mM) and very large glucose concentrations (e.g., greater than 400 mM, at or greater than about 500 mM, etc). It is anticipated that such correlations will persist to approximately the saturation concentration of glucose in the assay.

As further indicated above, the detector employing MV as an organic dye mediator (FIG. 5) comprised KOH as a base, while the detector employing indigo carmine as an organic dye mediator (FIG. 6) comprised NaOH as a base. That the linear correlation is found in both reagent systems indicates that glucose may be inferred in a predictable fashion using a variety of different organic mediator dyes and bases.

It may be additionally observed that the linear correlation between glucose concentration and current density changes when the combination of reagents used in the assay changes. For example, FIG. 5 (MV dye and KOH base) exhibits a linear correlation described by y=0.0001*x+0.0012, while the example of FIG. 6 (indigo carmine dye and NaOH base) exhibits a linear correlation described by y=2.1294*x, where x is glucose concentration and y is current density. The difference in the linear correlations indicates that different combinations of organic mediator and base may be employed to provide glucose detection.

Furthermore, this observation indicates that different combinations of reagents may be employed in view of the glucose concentration (e.g., relatively high, relatively low, etc.) within the assay in order to increase the current density output and increase the sensitivity of the detector. In general, by performing tests to examine the current-glucose concentration using known concentrations of glucose and different combinations of dye, base, temperature and pressure, the set of conditions and reagents that gives the best readings (e.g., highest current output) in the concentration range most likely to be in a selected glucose sample.

For example, the current-glucose concentration of FIG. 6 (indigo carmine dye and NaOH base) illustrates a current output of approximately 0.82 mA/cm⁻² at a glucose concentration of approximately 0.4 M, while the current-glucose concentration of FIG. 5 (MV dye and KOH base) illustrates a current output of approximately 0.052 mA/cm⁻² at a glucose concentration of approximately 0.4 M. Therefore, in certain embodiments, detectors employing indigo carmine dye and NaOH base may be desired for use over use of MV dye and KOH base with samples having a relatively low glucose concentration, as the detector output is greater at a given glucose concentration with indigo carmine dye and NaOH.

### Example 3

### Performance of Other Carbohydrates

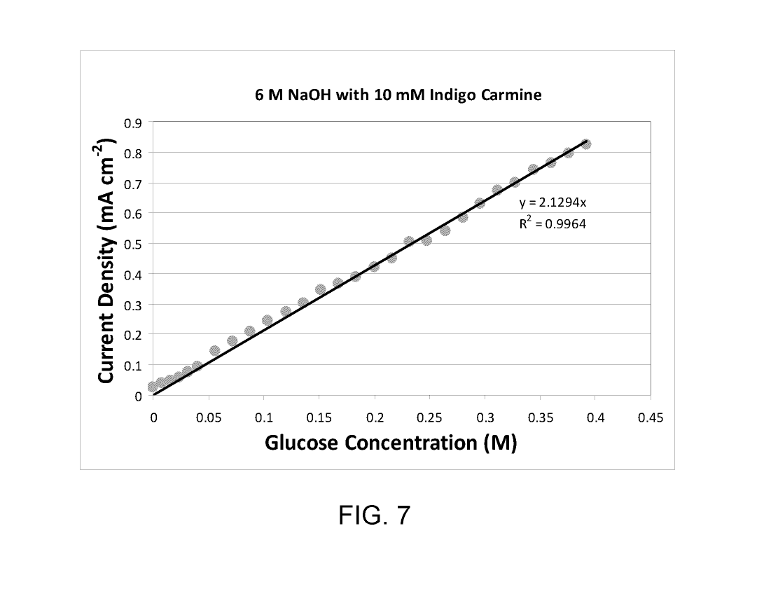

In Example 3, tests were performed to evaluate the performance of embodiments of the detector employing carbohydrates other than glucose. Examples of such carbohydrates may include monosaccharides, but are not limited to, arabinose, sorbose, and fructose. The performance of a representative detector comprising arabinose in various concentrations is illustrated in FIG. 7. The detector further comprised about 10 mM methyl viologen and about 2 M KOH in solution.

The results of FIG. 7 illustrate that arabinose and other carbohydrates may perform equally well as those shown in the previous Examples 1-2.

### Example 4

### Durability Testing

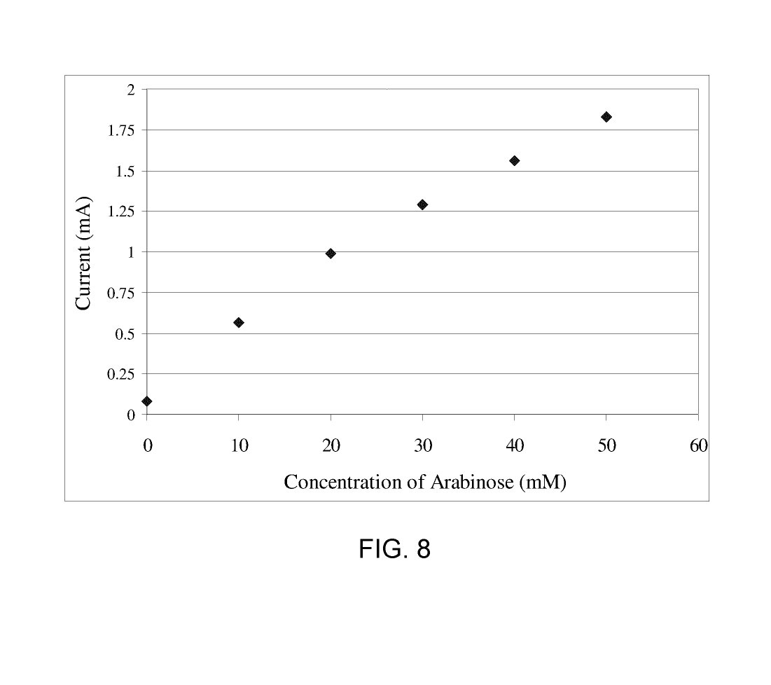

In Example 4, a detector was prepared for durability testing. The detector comprised about 1.6 mL of about 400 mM glucose in about 6 mM methyl viologen and about 1M KOH. The detector was further subjected to galvanostatic polarization at about 0.7 mA, and the results are illustrated in FIG. 8. As illustrated in FIG. 8, the open circuit voltage was about 0.64 V and the detector ran for more than about 18 hours, without stirring buffering, or substantially any other adjustment to the pH of the detector. These results indicate that embodiments of the detector are capable of detecting glucose concentrations for many hours using a single assay.

### Example 5

### Response Time

In Example 5, the current response from a carbon-felt anode of about 5.3 mg under short-circuit condition imposed by the VMP3 galvanostat was monitored when as aliquots of about 10 mM glucose were intermittently added to a solution containing only about 1 M KOH and about 4 mM methyl viologen, initially. In this manner, the response of the detector to glucose concentrations within the range from about 10 mM to about 50 mM were examined. The solution was also stirred after each addition to improve the response time.

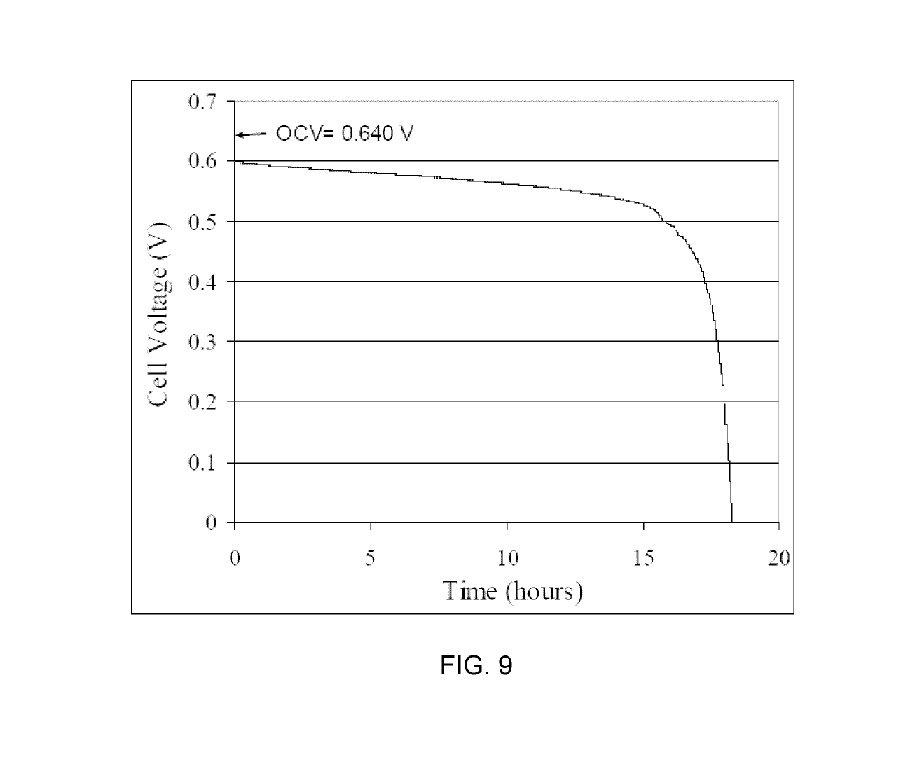

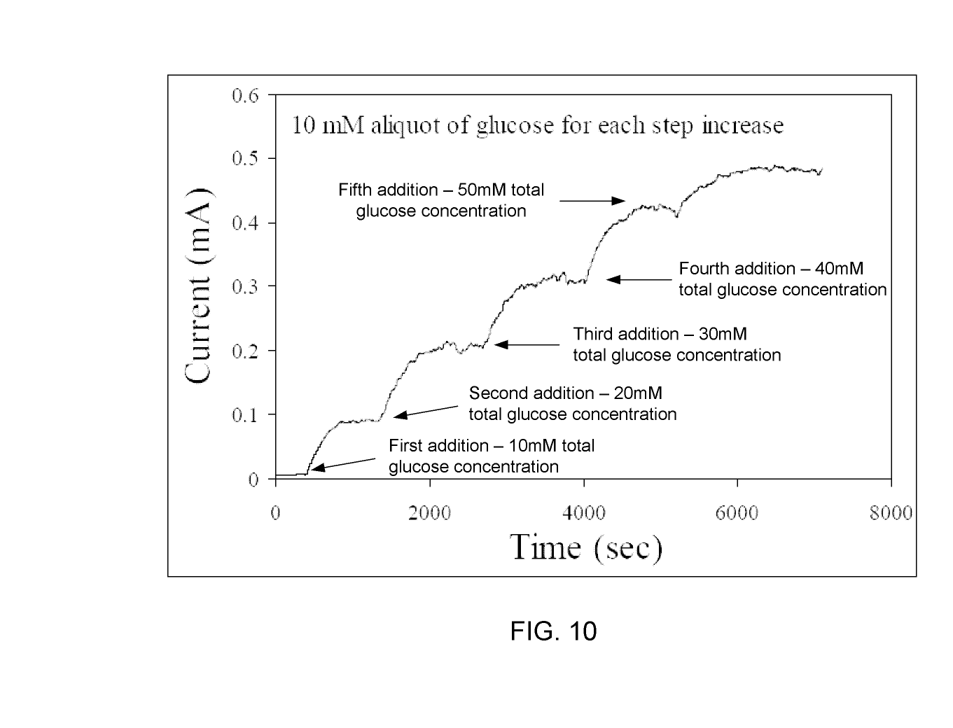

The results of glucose addition as a function of time are illustrated in FIG. 9. It may be seen that, after each increase in glucose concentration, the current output increased. Furthermore, after an initial transient, the output current increases to a relatively constant value. The transient period varied over the range of about 450 seconds (7.5 min) to about 930 seconds (15.5 minutes), indicating that the detector responds relatively quickly to changes in glucose concentration. Furthermore, the detector responds relatively quickly to changes in glucose concentration over a range of glucose concentrations.

### Discussion of Results

From the literature, it is known that in enzymatic bio-fuel cells, glucose oxidation occurs in a two-electron process, due to the selective nature of the enzyme catalysis, as follows:

### On the Anode:

β-D-glucose→δ-gluconolactone+2H⁺+2e⁻ (1)

### On the Cathode:

O₂+4H⁺+4e⁻→2H₂O (2)

### Detector:

2β-D-glucose+O₂→2δ-gluconolactone+2H₂O (3)

In microbial bio-fuel cells, the metabolism in the living cells can drive the glucose oxidation completely to CO₂ according to:

### On the Anode:

β-D-glucose+6H₂O→6CO₂+24H⁺+24e⁻ (4)

### On the Cathode:

O₂+4H⁺+4e⁻→2H₂O (5)

### Detector:

β-D-glucose+6O₂→6CO₂+6H₂O (6)

However, these reactions usually depict those in the acidic or neutral pH conditions. In embodiments of the detectors discussed herein with alkaline environments with the presence of dye (e.g., MV), the glucose oxidation could occur through a different pathway, from partial oxidation (7) to complete oxidation (8) and likely depend upon the dye activity and pH:

### On the Anode:

β-D-glucose+2MV²⁺+2OH⁻→δ-gluconolactone+2H₂O+2MV.⁺ (7)

β-D-glucose+24MV²⁺+24OH⁻→6CO₂+24H₂O+2MV.⁺ (8)

The reduced MV (MV.⁺) will donate the electron and reoxidize on the anode surface according to:

### On the Anode:

MV.⁺ [symbol] MV²⁺+e⁻ (9)

### On the Cathode:

O₂+2H₂O+4e⁻→4OH⁻ (10)

### Detector:

2β-D-glucose+O₂→2δ-gluconolactone (11)

It is important to note that the redox MV basically functions as an electron shuttle medium, while the partial oxidation of glucose actually occurs in the solution in the presence of hydroxide ions. Previous studies further suggest that OH⁻ interacts with glucose in the formation of the glucose-ene-diol. This ene-diol likely serves as the electron transfer intermediate. The product of this reaction would be gluconolactone. It is unlikely that further oxidation would occur, because the lactone and its derivative are quite stable. It is an open question whether the complete oxidation of glucose can be achieved with a single mediator like viologen. Such a pathway requires a number of C—C bonds to be broken down by the mediator.

The common power generation profile shared by glucose and dye over a wide range of concentration is a unique feature. As observed above, the anode exhibits the redox potential of methyl viologen at open circuit, and such potential is substantially independent of glucose concentration. It is evident that the anodic reaction indeed involves the oxidation of reduced methyl viologen (MV.⁺) as described in (9). Such methyl viologen redox reaction and its applications in providing electron shuttling between substrate reaction at bioelectroactive center and current collecting electrode surface have often been used in mediated bio-electrics for biosensing and bio-fuel cell applications. The insensitivity of open circuit potential to glucose concentration also implies that glucose is not electroactive on the anode surface.

Example 5 also illustrated that the current/power generation only takes place in the presence of glucose and, therefore, the current output of the detector is in response to the presence of glucose. Variations of glucose or dye concentration in 3 M KOH solution may affect the electron transfer rate and thus alter the amount of reduced methyl viologen available for current/power generation. These experiments indicate a commonly shared power profile for glucose and dye, therefore, the current appears to reflect the flux of reduce dye arriving at the anode. It may be further inferred that the maximum power is contingent on the flux of the dye at its mass transport limit for a specific concentration and, once the imposed galvanostatic polarization exceeds such mass transport limit, the detector will run to short circuit, which explains the rapid drop off of the detector voltage to the short circuit condition beyond the maximum power.

This mechanism is very different from that of traditional fuel cells, where the fuel redox reactions occur on the electrode surfaces (or electrolyte/electrode interface) and require help with catalysts. This unique nature also provides an opportunity to operate the detector at a substantially optimal volume-to-surface ratio with a minimum mass transport limitation.

Given the multi-body interactions involved in the electron transfer, whether on the electrode surface or in the solution, detailed stepwise reaction mechanism should be further investigated to provide more insight into how this system works and to push the extent of oxidation for better use of the fuels. Postulated, as if the partial oxidation two-electron process in (8) prevailed, a coulombic charge transfer efficiency on the order of about 30-40% may be derived on the basis of several long galvanostatic experiments in which the depletion of glucose in the solution was perceived as evident by the apparent decrease in voltage at the end of the detector operation under a galvanostatic condition. A 1.6 mL solution of about 400 mM glucose in about 6 mM methyl viologen and about 1 M KOH can generate about 0.7 mA over about 18.3 hours (Example 4) which is about 37% in coulombic efficiency.

The cause of parasitic loss in coulombic efficiency remains ambiguous at this time. One possible loss could be the formation of peroxides as the reactive enediol form of glucose interacts with O₂, which could poison the cathode reaction. Another possible cause is related to the stability of the dye in the charge transfer cycle. It has been reported that overly reduced MV to MV⁺⁺ may become inactive in electron transfer. Another cause of parasitic loss may be due to oxygen, as it is known for its affinity to oxidize reduced dyes quickly.

The possible interference of CO₂ in the air and the associated bicarbonate-carbonate formation and shuttle process, which may lead to efficiency loss has also been noted. Although it is known that CO₂ in the air and the bicarbonate/carbonate formation interfere with cell operation in alkaline fuel cells and metal-air batteries, no substantial interference in the detector operation was observed. However, the results illustrated herein show no substantial difference in the maximum power generation between aerobic and anaerobic conditions. Furthermore, this is anticipated to be the case for all dye mediators discussed herein.

In summary, embodiments of systems and methods for detecting carbohydrates such as monosaccharides (e.g., glucose) through an amperometric technique are described and demonstrated. Linear correlations between carbohydrate concentration and current output of the detector are observed, indicating that glucose (or other carbohydrate) concentration may be determined from the current output of the detector. It has been further demonstrated that a variety of organic dyes and bases may be employed in conjunction with the carbohydrate to affect the current output for a given glucose concentration. Thus, sensitivity of the detector may be varied by changing the organic dye and base employed in the detector. The detectors are also capable of operating without a catalyst (e.g., precious metals or biocatalysts) at the anode of the detector, enabling the detector to operate at a wide temperature range.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or sub-combinations of the specific features and aspects of the embodiments may be made and still fall within one or more of the inventions. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above but should be defined by the appended claims.

What is claimed is:

1. A method of measuring the concentration of a carbohydrate in a sample, the method comprising:
contacting an anode and a cathode with two or more first alkaline solutions, the alkaline solutions each comprising a known concentration of the carbohydrate and a mediator dye selected from the group consisting of azides and carmines;
identifying a correlation between the current output resulting from contacting the anode and the cathode with each of the two or more first alkaline solutions and the concentration of carbohydrate in the first alkaline solutions;
contacting the anode and the cathode with a second alkaline solution comprising the sample, wherein the sample comprises an unknown concentration of the carbohydrate;
measuring a current output resulting from contact of the anode and the cathode with the second alkaline solution; and
determining the concentration of the selected carbohydrate within the second alkaline solution using the identified correlation.

2. The method of claim 1, wherein the anode and the cathode are contacted at a temperature less than about 35° C.

3. The method of claim 1, wherein the anode comprises at least one of a glassy carbon and a carbon felt.

4. The method of claim 1, wherein the carbohydrate comprises a monosaccharide.

5. The method of claim 1, wherein the carbohydrate is selected from the group consisting of glucose, arabinose, sorbose, and fructose.

6. The method of claim 1, wherein the carbohydrate is glucose.

7. The method of claim 1, wherein the dye is methyl viologen.

8. The method of claim 1, wherein the dye is selected from the group consisting of Medola's blue, methylene blue, methylene green, indigo carmine, and safranin O.

9. The method of claim 1, wherein the alkaline solution further comprises a hydroxide (OH⁻) containing base.

10. The method of claim 9, wherein the base is provided in a concentration such that the pH of the alkaline solution is greater than about 14.

11. The method of claim 1, wherein the alkaline solution is not stirred.

12. The method of claim 1, wherein the alkaline solution is not buffered.

13. The method of claim 1, wherein the anode and the cathode are contacted with the first and the second alkaline solutions at about atmospheric pressure.

14. A method of correlating a current output to a carbohydrate concentration, comprising:
performing a first reaction process comprising:
reacting a known concentration of a selected carbohydrate with an oxidized form of a dye and hydroxide ions in an alkaline solution to yield at least a reduced from of the dye and an oxidized form of the carbohydrate;
oxidizing the dye at the anode to recover the oxidized form of the dye and one or more electrons; and
reacting oxygen with water and the one or more produced electrons at a cathode to form hydroxide ions; and
measuring a correlation between the current resulting from the first reaction process and the concentration of the selected carbohydrate.

15. The method of claim 14, wherein the correlation is a linear correlation.

16. The method of claim 14, further comprising:
measuring a current output resulting from a second reaction process employing an unknown concentration of the selected carbohydrate; and
determining the concentration of the selected carbohydrate in the second reaction process from the linear correlation measured in the first reaction process and the current output resulting from the second reaction process.

17. The method of claim 14, wherein carbon dioxide is not a product of the reaction.

18. The method of claim 14, wherein the dye is selected from the group consisting of azides and carmines.

19. The method of claim 14, wherein the anode comprises one of a glassy carbon and a carbon felt.

20. The method of claim 14, wherein the carbohydrate comprises a monosaccharide.

21. The method of claim 14, wherein the carbohydrate is selected from the group consisting of glucose, arabinose, sorbose, and fructose.

22. The method of claim 14, wherein the carbohydrate is glucose.

23. The method of claim 14, wherein the dye is methyl viologen.

24. The method of claim 14, wherein the dye is selected from the group consisting of Medola's blue, methylene blue, methylene green, indigo carmine, and safranin O.

25. The method of claim 14, wherein the pH of the alkaline solution is greater than about 14.

26. The method of claim 16, wherein the first and second reaction processes are performed at a temperature less than about 35° C.

27. A method of determining a concentration of a carbohydrate within a sample, comprising:
contacting an anode and a cathode with a solution comprising a dye selected from the group consisting of azides and carmines and a carbohydrate;
measuring the current output resulting from contact of the anode and cathode with the solution; and
determining the concentration of the carbohydrate based upon a relationship between the current output and the concentration of the carbohydrate under approximately identical conditions.

28. The method of claim 27, wherein the anode and the cathode are contacted at a temperature less than about 35° C.

29. The method of claim 27, wherein the anode comprises at least one of a glassy carbon and a carbon felt.

30. The method of claim 27, wherein the carbohydrate comprises a monosaccharide.

31. The method of claim 27, wherein the carbohydrate is selected from the group consisting of glucose, arabinose, sorbose, and fructose.

32. The method of claim 27, wherein the carbohydrate is glucose.

33. The method of claim 27, wherein the dye is methyl viologen.

34. The method of claim 27, wherein the dye is selected from the group consisting of Medola's blue, methylene blue, methylene green, indigo carmine, and safranin O.

35. The method of claim 27, wherein the alkaline solution further comprises a hydroxide (OH⁻) containing base.

36. The method of claim 35, wherein the base is provided in a concentration such that the pH of the alkaline solution is greater than about 14.
